(19) United States
(12) Patent Application Publication
(10) Pub. No.: US 2010/0258572 A1
(43) Pub. Date: Oct. 14, 2010

(54) MULTI-CELL TANK FOR PRESSURISED GAS

(76) Inventor: Nicolantonio Luongo, Falconara Maritima (IT)

Correspondence Address: HODES, PESSIN & KATZ , P.A, 901 DULANEY VALLEY ROAD , SUITE 400, BALTIMORE, MD, 21204, US

(21) Appl. No.: 12/303,608

(22) PCT Filed: May 31, 2007
(86) PCT No.: PCT/IT07/00383

§ 371 Date: Dec. 5, 2008

(30) Foreign Application Priority Data
Jun. 13, 2006 (IT) MC2006A000074

(51) Int. Cl. F17C 1/02; B65D 25/04

(52) U.S. Cl. 220/581; 220/507

(57) ABSTRACT

The present invention relates to a tank for pressurised gas composed of multiple cells joined by means of connection plates (P), in which each cell (C) is composed of a tubular body sealed at the two ends by means of two caps (2) and the adjacent cells communicate in pairs through a series of ducts, which comprises one or more radial ducts (5) obtained on the head (2a) of each cap (2), annular ducts (9) that surround the head (2a) of each cap (2) and transversal holes (10) obtained on the connection plates (P) and designed to provide communication between the adjacent pairs of annular ducts (9).

The present patent application relates to an improved multi-cell tank for pressurised gas.

The same applicant is the holder of the European patent application no. 02794829.8 that relates to a tank for pressurised gas having a modular structure that allows for construction with variable volumes and capacities according to the specific requirements.

According to the first constructive version, the multi-cell tank was devised as an alternative proposal to traditional steel cylinder, being characterised by higher operating safety, easier inspection, lower weight, higher flexibility of shapes and dimensions with the same capacity.

According to the first constructive version, the said multi-cell tank was composed of:
A group of tubes supported by spacing plates with a parallel close series of holes suitable for housing similar tubes that are placed in such a way that each tube is almost in contact with the adjacent tubes in order to reduce the dimensions;
A body made of fibrous resin that fills all the spaces in the group of tubes, including the perimeter ones, where the resin is perfectly flush with the borders of the said spacing plates;
Two covers used to close the ends of the said group of tubes, provided on the internal side with a series of hemispherical domes that communicate through ducts and exactly match the opening of the tubes that form the said group of tubes;
Tie rods used to join the two aforementioned covers to the group of tubes, passing through the spaces in the group of tubes through suitable holes provided on the spacing plates;
One external reinforcement layer obtained by winding in a resin-bonded texture with continuous wire, on which a second texture with resin-bonded longitudinal wires is laid in order to join the covers that have been previously applied and tightened by means of the said tie rods to the group of tubes;
One preformed protection enclosure, preferably obtained from a thin aluminium sheet;
One ordinary gas delivery valve applied in a hole drilled on one of the two covers.

The main purpose of the present invention is to simplify the structure of the said multi-cell tank in order to reduce construction costs, while maintaining the aforementioned advantages with respect to traditional steel cylinders.

According to the improved version of the present invention, the spacing plates, the tie rods, the resin body and the reinforcement enclosure have been eliminated with respect to the previous version.

The new cell used to obtain the new tank of the invention is formed of a tubular core, externally coated with a carbon composite shell with the known technique defined as “filament winding”.

The main purpose of the tubular core is to ensure tightness with respect to the gases compressed inside the cell, since the same is not guaranteed by the external carbon composite shell that purely has a structural function, meaning that it withstands the heavy mechanical stress derived from the very high compression (i.e. several hundreds of bar) of the gas introduced in the cell.

More precisely, the core is preferably made of aluminium and formed of a tube, whose ends are welded with two joints provided with threaded opening and screwed onto the caps that act as closing bottom for each end of the cylindrical cell.

The peculiarity of the said caps is that the head without thread is provided with an external annular groove where one or more radial through ducts end, providing communication between the groove and the inside of the cell.

When multiple cells of this type are coupled one next to the other to create the multi-cell modular tank, an opposite pair of connection plates is applied on the two opposite ends of the cell pack that forms the tank of the invention.

More precisely, each connection plate is provided with a series of circular through housings that are identical, correspondent and coaxial to the threaded openings of the said joints, with the circular housings being engaged and perfectly aligned with them, being characterised by the presence on the border of an internal annular groove designed to be interfaced and perfectly matched with the corresponding annular groove in external position on the head of the caps, thus forming an annular duct that surrounds the head of each cap.

The annular ducts of the adjacent caps communicate through transversal holes that are suitably obtained in the connection plates to provide communication between the internal annular grooves of two adjacent circular housings.

A careful arrangement of the transversal holes provides a “serpentine” flow of the gas inside the multi-cell tank, starting from a first load cell provided with the inlet valve, and reaching the last cell provided with the outlet valve of the tank.

The two connection plates are tightened against the threaded opening of the joints by means of the caps that are tightened inside the said joints until their head is engaged and stopped inside the circular housings.

For purposes of clarity, the description of the tank of the invention continues with reference to the enclosed drawings, which are intended for purposes of illustration only and not in a limiting sense, whereby:

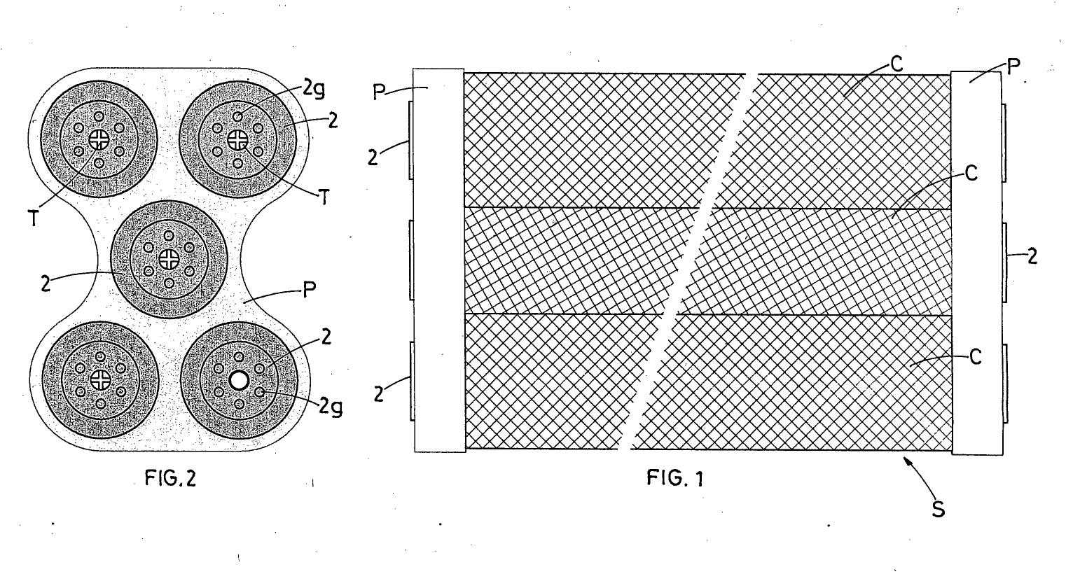

FIG. 1 is a side view of the multi-cell modular tank of the invention;

FIG. 2 is a view of one of the two caps of the tank shown in FIG. 1;

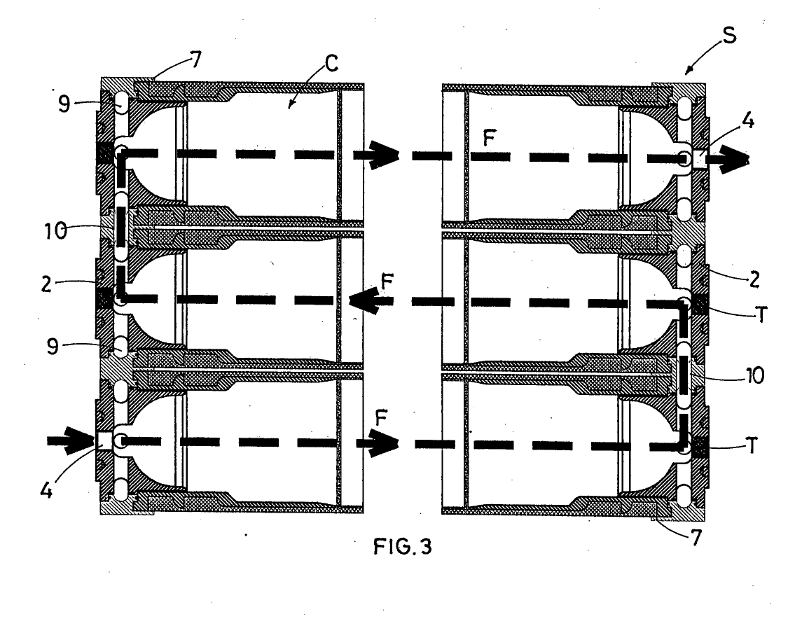

FIG. 3 is a sectional view of the tank of the invention with plane III-III of FIG. 2;

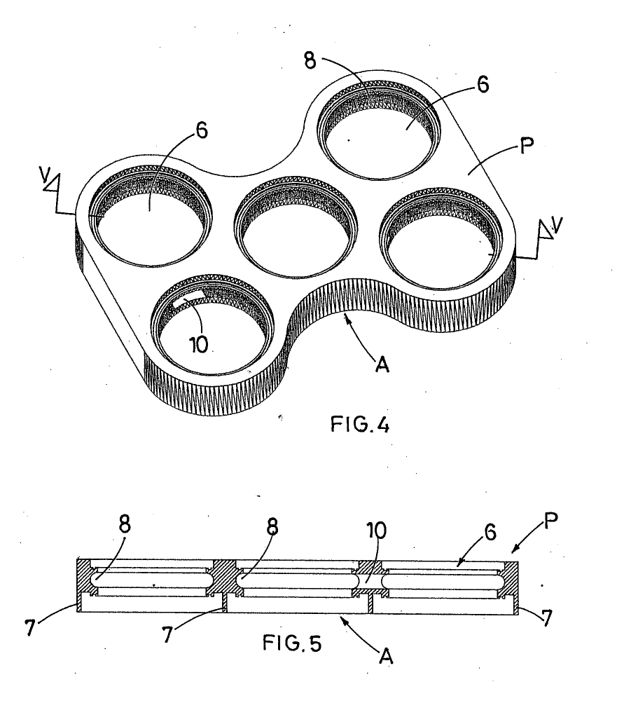

FIG. 4 is an axonometric view of one of the two opposite connection plates dismounted from the tank;

FIG. 5 is a sectional view of one of the two opposite connection plates with plane V-V of FIG. 4 dismounted from the tank;

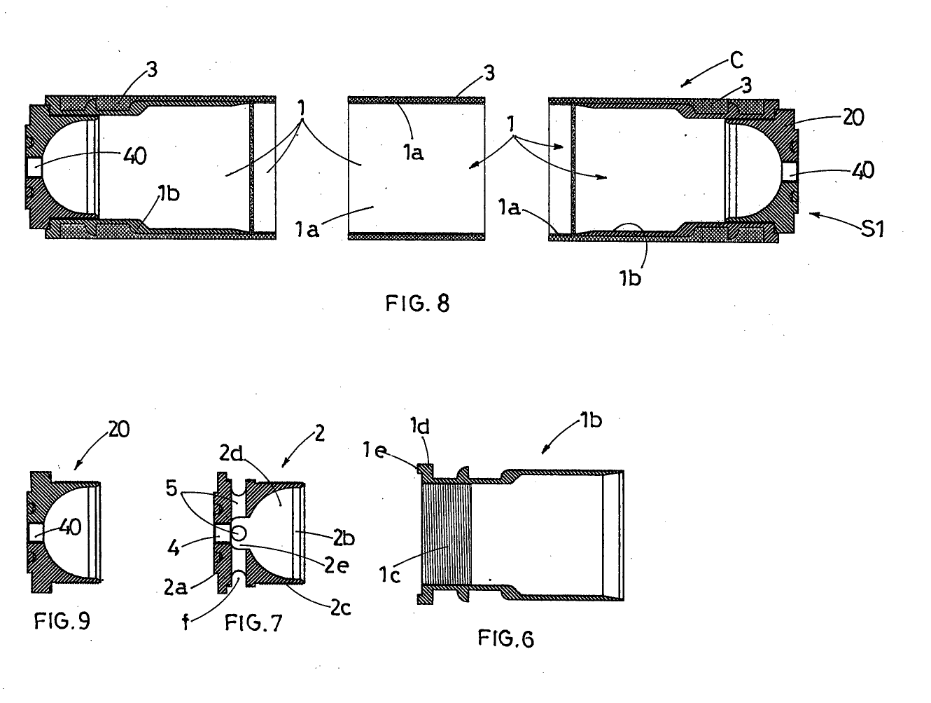

FIG. 6 is a sectional view of the joints with threaded opening with an axial plane;

FIG. 7 is a sectional view of one of the caps with an axial plane;

FIG. 8 is a sectional view of the mono-cell version of the tank of the invention with an axial plane;

FIG. 9 is a sectional view of a different constructive version of the said caps, suitable for the mono-cell tank of FIG. 8, with an axial plane.

The tank (S) shown in FIGS. 1 and 2 is composed of a pack of five identical cells (C) placed one next to the other and held by means of a pair of identical connection plates (P) that surround the opposite ends of all the cells (C) of the pack.

Each cell (C) is formed of a tubular body sealed at the two ends by means of two caps.

As shown in FIG. 8, the tubular body is formed of an internal core (1) and an external coating (3) made of carbon composite and wound around the core (1) with the technique known as “Filament Winding”.

The core (1) is formed of a tube (1a) that ends with two end joints (1b) with threaded opening (1c).

According to the preferred embodiment of the invention, the end joints (1b) are welded, preferably with TIG process, to the two ends of the tube (1a) and coated with the said carbon composite coating (3) together with the tube (1a). In particular, as shown in FIG. 5, the threaded opening (1c) is provided with an external flange (1d) with raised border (1e), in which the seal ring (not shown in FIG. 3) and the head of the cap (2) are engaged.

As shown in FIG. 7, each cap (2) is composed of a circular head (2a) and a cylindrical body (2b) with external thread (2c) and an internal cavity (2d) shaped as a dome, provided on top with a circular niche (2e) engraved in the head (2a), which has an external annular groove (2f) with semicircular profile. An axial hole (4) ends in the niche (2e) and goes through the head (2a), being designed to act as attachment for the gas inlet or outlet valve or for a cover (T).

One or more radial ducts (5) end in the same niche (2e), more precisely in number of four, that provide communication between the external groove (2f) and the internal niche (2e).

The head (2a) is provided with a regularly spaced annular series of circular indentations (2g) that act as connection points for the bifurcated key used to tighten the cap (2).

As shown in FIGS. 4 and 5, each connection plate (P) has a series of identical circular housing, (6) more precisely in number of five, designed to receive the caps (2) and be coaxially engaged against the threaded openings (1c) of the joints (1b).

In particular, each connection plate (P) is provided on the internal side (A) with a series of raised borders (7) that surround the ending section of the tubular body (1) of each cell (C), as shown in FIG. 3.

The circular housings (6) are provided on the border with an internal annular groove (8) with semi-circular profile, designed to be interfaced and perfectly matched with the annular groove (2f)—when the caps (2) are inserted through the housings (6) and screwed in the end joints (1b)—in such a way to form an annular duct (9) that surrounds the head (2a) of each cap (2), as shown in FIG. 3.

The annular ducts (9) of the adjacent caps (2) communicate through transversal holes (10) that are suitably obtained in the connection plates (P) to provide communication between the internal annular grooves (8) of two adjacent circular housings (6), as shown in FIG. 5.

A careful arrangement of the transversal holes (10) provides a “serpentine” flow (F) of the gas inside the multi-cell tank, starting from a first load cell provided with the inlet valve, and reaching the last cell provided with the outlet valve of the tank, as shown in FIG. 3.

FIG. 8 shows a mono-cell tank (S1) not provided with the connection plates (P), being formed of only one cell (C) closed with simple caps (20) that are only provided with a central hole (40) for the attachment of the inlet or outlet valve.

1. Improved multi-cell tank for pressurized gas, of the type composed of a pack of identical cells (C) placed one next to the other and held by means of two connection plates (P), characterized by the fact that each cell (C) is composed of a tubular body sealed at the two ends by means of two caps (2) and by the fact that the adjacent cells communicate in pairs through a series of ducts, which comprises one or more radial ducts (5) obtained on the head (2a) of each cap (2), annular ducts (9) that surround the head (2a) of each cap (2) and transversal holes (10) obtained on the connection plates (P) and designed to provide communication between the adjacent pairs of annular ducts (9).

2. Tank as claimed in claim 1, characterized by the fact that each cell (C) has a tubular body composed of an internal core (1) and an external coating (3) made of carbon composite and wound around the core (1).

3. Tank as claimed in claim 2, characterized by the fact that the core (1) is composed of a tube (1a) ending with two joints (1b) with threaded opening (1c) used to screw the caps (2).

4. Tank as claimed in claim 3, characterized by the fact that the end joints (1b) are welded at the two ends of the tube (1a) and are coated with the carbon composite coating (3) together with the tube (1a).

5. Tank as claimed in claim 1, characterized by the fact that each cap (2) is composed of a circular head (2a) and a cylindrical body (2b) with external thread (2c) and internal cavity (2d), shaped as a dome, provided on top with a circular niche (2e) engraved in the head (2a), which has an external annular groove (2f), an axial hole (4) and one or more radial ducts (5) that provide communication between the external groove (2f) and the internal circular niche (2e).

6. Tank as claimed in claim 1, characterized by the fact that each cap (2) is provided on the head (2a) with a regularly spaced annular series of circular indentations (2g) designed to act as connection points for a bifurcated key used to tighten the cap (2).

7. Tank as claimed in claim 5, characterized by the fact that each connection plate (P) has a series of identical circular housings (6), with the same number as the cells (C), designed to receive the caps (2) and provided on the border with an internal annular groove (8), designed to be interfaced and perfectly matched with the said annular groove (2f) of the caps, in such a way to form annular ducts (9) that communicate through transversal holes (10) obtained on the connection plates (P) in order to provide communication between the internal annular grooves (8) of two circular adjacent housings (6).

8. Tank as claimed in claim 1, characterized by the fact that each connection plate (P) is provided on the internal side (A) with a series of raised borders (7) that surround the ending section of the tubular body (1) of each cell (C).

9. Tank as claimed in claim 7, characterized by the fact that the transversal holes (10) are arranged in such a way to obtain a “serpentine” flow (F) of the gas inside the multi-cell tank, starting from a first load cell provided with an inlet valve, and reaching a last cell provided with an outlet valve of the tank.

10. Tank as claimed in claim 3, characterized by the fact the threaded opening (1c) is provided with an external flange (1d) with raised border (1e), in which the seal ring and the head (2a) of the cap (2) are engaged.

11. Tank for pressurized gas composed of only one cell (C), characterized by the fact that the cell (C) is composed of a tubular body sealed at the two ends by means of two caps (20) and by the fact that the tubular body is composed of an internal core (1) and an external coating (3) made of carbon composite wound around the core (1).

12. Tank as claimed in claim 11, characterized by the fact that the core (1) is composed of a tube (1a) ending with two end joints (1b) with threaded opening (1c) used to screw the caps (20).

13. Tank as claimed in claim 12, characterized by the fact that the end joints (1b) are welded at the two ends of the tube (1a) and are coated with the carbon composite coating (3) together with the tube (1a).
